(19) United States
(12) Patent Application Publication
(10) Pub. No.: US 2014/0021948 A1
(43) Pub. Date: Jan. 23, 2014

(54) NUCLEAR MAGNETIC FLOWMETER

(71) Applicant: Krohne AG, Basel (CH)

(72) Inventors: Jan Teunis Aart Pors, Oud-Beijerland (NL); Jan-Willem Ramondt, Breda (NL)

(21) Appl. No.: 13/943,125

(22) Filed: Jul. 16, 2013

(30) Foreign Application Priority Data
Jul. 16, 2012 (DE) 10 2012 013 934.9

(51) Int. Cl. G01F 1/716

(52) U.S. Cl. CPC G01F 1/716
USPC 324/306; 74/63

(57) ABSTRACT

A nuclear magnetic flowmeter with a measuring tube, a signal apparatus for generating signals to excite a medium flowing through the tube and/or for evaluating signals of the excited medium, at least one signal coil located on the measuring tube for sending signals from the signal apparatus and/or for receiving signals of the excited medium and a matching device between the signal apparatus and the signal coil which has a reactive adjustment object a value of which can be rotationally adjusted mechanically and an adjusting apparatus which is assigned to the adjustment object. The adjustment apparatus has a rotary final control element which influences the adjustment object, a rotary actuator which acts on the rotary final control element, a torque clutch between the rotary actuator and the rotary final control element which transmits a torque generated by the rotary actuator to the rotary final control element, and a rotary stop.

### BACKGROUND OF THE INVENTION

1. Field of the Invention

The invention relates, first of all, to a nuclear magnetic flowmeter, with a measuring tube through which a medium can flow, with a signal apparatus for generating signals which excite the medium and/or for evaluating the signals of the excited medium, with at least one signal coil which is located on the measuring tube for sending the signals which have been generated by the signal apparatus and/or for receiving the signals of the excited medium and with a matching device which is provided between the signal apparatus and the signal coil, the matching device having a reactive adjustment object which can be adjusted mechanically in its value by a rotary motion and an adjusting apparatus which is assigned to the adjustment object. The invention also relates to an adjusting apparatus for an adjustment object the value of which can be adjusted by a rotational motion. Finally, the invention also relates to a method for operating an adjusting apparatus for an adjustment object the value of which can be adjusted by a rotational motion.

2. Description of Related Art

The atomic nuclei of the elements which have a nuclear spin also have a magnetic moment which is caused by the nuclear spin. The nuclear spin can be construed as an angular momentum which can be described by a vector, and accordingly, the magnetic moment can also be described by a vector which is parallel to the vector of the angular momentum. The vector of the magnetic moment of an atomic nucleus in the presence of a macroscopic magnetic field is aligned parallel to the vector of the macroscopic magnetic field at the location of the atomic nucleus. The vector of the magnetic moment of the atomic nucleus precesses around the vector of the macroscopic magnetic field at the location of the atomic nucleus. The frequency of the precession is called the Larmor frequency ω_{L} and is proportional to the amount of the magnetic field strength B. The Larmor frequency is computed according to ω_{L}=γ·B. In the latter, γ is the gyromagnetic ratio which is maximized for hydrogen nuclei.

Measurement and analysis methods which use the property of the precession of atomic nuclei with a magnetic moment in the presence of a macroscopic magnetic field are called nuclear magnetic resonance measurement or analysis methods. Usually, the voltages induced by the precessing atomic nuclei under various boundary conditions in a sensor coil are used as the output variable for the measurement and analysis methods. One example for measuring instruments which use nuclear magnetic resonance are the nuclear magnetic flowmeters which measure the flow rate of the multiphase medium flowing through the measuring tube and analyze the medium.

The prerequisite for an analysis using nuclear magnetic resonance is that the phases of the medium which are to be analyzed can be excited to distinguishable nuclear magnetic resonances. The analysis can comprise the flow velocities of the individual phases of the multiphase medium and the relative proportions of the individual phases in the multiphase medium. Nuclear magnetic flowmeters can be used, for example, to analyze the multiphase medium extracted from oil sources, a medium which consists essentially of the crude oil, natural gas and salt water phases, all of which contain hydrogen nuclei.

The medium extracted from oil sources can also be analyzed with so-called test separators. They branch off a small part of the extracted medium, separate the individual phases of the medium from one another and determine the proportions of the individual phases in the medium. But test separators are not able to reliably measure proportions of crude oil smaller than 5%. Since the proportion of crude oil of each source continuously drops and the proportion of crude oil of a host of sources is already less than 5%, it is not currently possible to economically exploit these sources using test separators. In order to also be able to furthermore exploit sources with a very small proportion of crude oil, correspondingly accurate flowmeters are necessary.

Nuclear magnetic flowmeters can meet the demands of a host of applications, such as, for example, in the measurement of the flow rate of the multiphase medium extracted from a source through the measuring tube and in the determination of the proportions of crude oil, natural gas and salt water in the medium. Proportions of crude oil less than 5% can also be measured with nuclear magnetic flowmeters.

It follows from what was stated at the beginning that, for operation, a nuclear magnetic flowmeter necessarily includes a magnetization apparatus, a signal apparatus, a signal coil and a matching apparatus which is provided between the signal apparatus and the signal coil.

Moreover, the operation of the magnetization apparatus, the operation of the signal apparatus and the operation of the signal coil easily follow from what was stated above on the manner of physical operation of nuclear magnetic flowmeters. The operation of the matching apparatus which is provided between the signal apparatus and the signal coil requires explanation.

Both the signal apparatus and also the signal coil each have a double function. The signal apparatus is used to generate the signals which excite the medium and to evaluate the signals of the excited medium. The signal coil is used to send the signals which have been generated by the signal apparatus into the medium and to receive the signals of the excited medium. In other words, both the signal apparatus and also the signal coil each have one output and one input, and the output of the signal apparatus is connected to the input of the signal coil and the output of the signal coil is connected to the input of the signal apparatus.

If it has been stated above that both the signal apparatus and also the signal coil each have a input and an output, this is not necessarily meant in terms of circuit engineering, but only functionally. In fact, both in the signal apparatus and also in the signal coil the output and input can “coincide” in terms of circuit engineering, because specifically the reception of signals of the excited medium takes place offset in time relative to the sending of the signals which excite the medium.

The matching apparatus, which is provided between the signal apparatus and the signal coil, is used at this point to match the output impedance of the signal apparatus to the input impedance of the signal coil or the input impedance of the signal coil to the output impedance of the signal apparatus, and to match the output impedance of the signal coil to the input impedance of the signal apparatus or the input impedance of the signal apparatus to the output impedance of the signal coil. Otherwise, the matching apparatus is also used for frequency matching, i.e., the matching of the resonant frequency of the signal coil to the transmission frequency of the signal apparatus or the transmission frequency of the signal apparatus to the resonant frequency of the signal coil.

It was stated initially that, in the nuclear magnetic flowmeter under consideration, the matching apparatus has a reactive adjustment object the value of which can be adjusted mechanically by a rotational motion. In fact, the matching apparatus can include not only an adjustable reactive adjustment object, it can also include several different reactive adjustment objects. The matching apparatus can also include a capacitor or several capacitors and/or a coil or several coils. The matching apparatus can also have a resistor or several resistors. It is always assumed below, without any limitation, that the matching apparatus has only one rotary capacitor as a reactive adjustment object which can be rotationally adjusted.

The nuclear magnetic flowmeter in accordance with the invention also includes, as stated, mainly an adjusting apparatus assigned to the adjustment object.

### SUMMARY OF THE INVENTION

A primary object of the invention is, first of all, to provide the nuclear magnetic flowmeter with an adjusting apparatus which is especially suited for the explained function.

The nuclear magnetic flowmeter in accordance with the invention is, first of all, characterized essentially in that the adjusting apparatus has a rotary final control element which influences the adjustment object, a rotary actuator which acts on the rotary final control element, a torque clutch which is provided between the rotary actuator and the rotary final control element and which can transmit a torque generated by the rotary actuator to the rotary final control element, and a rotary stop. Here, the rotary actuator can be an electric motor, especially a stepping motor.

The nuclear magnetic flowmeter in accordance with the invention can be embodied and developed in different ways, especially with respect to the adjusting apparatus which characterizes the flowmeter.

First of all, it is recommended that in the adjusting apparatus which characterizes the flowmeter in accordance with the invention the torque clutch be configured such that the torque which can be transmitted from the rotary actuator to the rotary final control element and thus ultimately to the adjustment object is limited to a maximum torque. For this purpose, the torque clutch can be made as a slip clutch. But, an embodiment is especially preferred in which the torque clutch is made as a safety clutch, preferably as a safety clutch with angularly synchronous re-engagement.

It was stated at the beginning that the invention also relates to an adjusting apparatus for an adjustment object the value of which can be adjusted by a rotational motion. The adjusting apparatus provided in accordance with the invention, in the nuclear magnetic flowmeter in accordance with the invention, therefore, has importance not only in conjunction with a nuclear magnetic flowmeter, but also beyond that context.

Adjusting apparatus are used in the most varied applications. An adjusting apparatus acts on at least one process variable of a process in the widest sense by variation of one process parameter. Often, an adjusting apparatus has a rotary final control element whose rotary position within a rotational range corresponds to the magnitude of the process parameter. Conventional rotational ranges extend from less than one revolution to a plurality of revolutions. Generally, the rotational range is mechanically limited at least on one end by a rotary stop, and often the rotational range is mechanically limited on the two ends by rotary stops. Overrotation of the rotary final control element beyond a rotary stop is possible with a torque which has been increased compared to the rotation of the rotary final control element within the rotational range. But, overrotation of the rotary final control element beyond a rotary stop can damage or destroy the adjustment object apparatus.

Adjusting apparatus of the type under consideration in electrical engineering are, for example, rotary potentiometers and rotary capacitors. In a rotary potentiometer, the rotational position of the rotary final control element corresponds to the amount of resistance between two electrical terminals of the rotary potentiometer. With a rotary potentiometer, for example, the direct signal gain of an operational amplifier circuit can be adjusted. In a rotary capacitor, the rotary position of the rotary final control element corresponds to the amount of capacitance between two electrical terminals of the rotary capacitor. A rotary capacitor can be used, for example, to tune an electrical oscillating circuit.

The rotary position of the rotary final control element of an adjusting apparatus which acts by variation of a process parameter on at least one process variable which corresponds to a suitable value of at least one of the process variables is often determined by variation of the process parameter and by the determination and evaluation of at least one of the process variables. The knowledge of the quantitative relationship of at least one process variable to the rotary position is not necessary. Finding the suitable value of at least one of the process variables of a process generally begins with the rotary position of the rotary final control element on a rotary stop.

Often, the rotary final control element of an adjusting apparatus is not turned manually, but by a rotary actuator, the rotation of the rotary actuator being transferred to the rotary final control element. When using a rotary actuator, it must be ensured that the torque which has been generated by the rotary actuator is large enough for rotating the rotary final control element and that the rotary actuator which produces a torque does not damage the adjusting apparatus. Damage can occur especially when the rotary position of the rotary final control element is on a rotary stop and the rotary actuator continues to produce a torque.

The prior art discloses adjusting apparatus in which the rotational position of a rotary final control element is tracked by a monitoring device. By knowing the current rotary position of the rotary final control element and the position of the rotary stop, the rotary final control element can be turned by the rotary actuator onto the rotary stop without the risk of damage or even destruction of the adjusting device and especially of the rotary stop by the torque which has been applied by the rotary actuator. If a dc motor or a synchronous motor is used as the rotary actuator, the monitoring device usually comprises a rotary transducer, for example, in the manner of an incremental transducer or absolute value transducer which reproduces the rotary position of the rotary final control element by electrical signals. If a stepping motor is used, often only the actuating signals of the stepping motor are evaluated. Regardless of the selected implementation, in addition, electronics for evaluation of the signals which reproduce the rotary position are necessary and the monitoring device means a major cost and the necessity of storage especially of the current rotary position.

Therefore, the adjustment apparatus which are known from the prior art fail when the knowledge of the current rotary position is lost. This can happen, for example, by a power failure. The rotational position can also be unknown during start-up. If the rotational position is unknown, there is again the risk that the rotary actuator will damage or even destroy the adjusting device and especially the rotary stop by the torque which has been generated by it since the rotary actuator is not turned off when the rotational position of the rotary final control element has reached the rotary stop.

The subject matter of the invention is an adjusting apparatus which, as described above, characterizes the nuclear magnetic flowmeter in accordance with the invention, also with features which embody and develop this adjusting apparatus, according to which a torque clutch limits the torque which can be transmitted from the rotary actuator to the rotary final control element to a maximum torque, according to which the torque clutch can be a slip clutch, preferably can be a safety clutch, and according to which when the torque clutch is a safety clutch, the safety clutch can have angularly synchronous re-engagement.

If in the adjusting apparatus in accordance with the invention the torque clutch is a slip clutch, it limits the torque which can be transmitted between the rotary actuator and the rotary final control element to the maximum torque.

If the torque coming from the rotary actuator exceeds the maximum torque, slip occurs between the rotary actuator and the rotary final control element, a slip which does not damage the slip clutch.

Instead of providing a slip clutch as the torque clutch, it can be recommended that a safety clutch be provided as the torque clutch, especially one which has angularly synchronous re-engagement.

If in the adjusting apparatus in accordance with the invention, there is a slip clutch as a torque clutch, when the rotary stop prevents further rotation of the rotary final control element, nevertheless the maximum torque is acting on the rotary final control element as long as the rotary actuator is working. But, if the torque clutch is a safety clutch, the safety clutch separates the rotary final control element from the rotary actuator when further rotary motion of the rotary final control element is prevented by the rotary stop. The maximum torque therefore acts on the rotary final control element only until the safety clutch has responded.

The subject matter of the invention is, as stated initially, also a method for operating an adjusting apparatus for an adjustment object which it is adjustable in its value by a rotary motion. This method is characterized in accordance with the invention in that the torque which can be transmitted between the rotary actuator and the rotary final control element is limited to a maximum torque, that when the maximum torque is exceeded between the rotary actuator and the rotary final control element slip is accomplished and that the rotary actuator executes rotation whose amount corresponds at least to the rotational range of the rotary final control element.

In the determination of the maximum torque, all parts of the adjusting apparatus which are stressed by the torque which has been generated by the rotary actuator are taken into account. Accordingly, not only the torque, but also the forces accompanying the torque are taken into account. In particular, the stresses on the rotary actuator and on the rotary stop are taken into account. Nonmechanical stresses, such as the thermal stress, on the rotary actuator with continuing generation of the maximum torque are also taken into account.

Since normally the rotational position of the rotary final control element is not known at first, for reliable rotation of the rotary final control element to the rotary stop, the rotary actuator must be able to execute a rotation at least of the magnitude of the rotational range of the rotary final control element. Rotation of the rotary actuator which is greater, even much greater, than the rotational range of the rotary final control element is not critical, since in the rotation of the rotary actuator which is greater than the rotational range of the rotary final control element, slip between the rotary actuator and the rotary final control element is accomplished, for example, by a slip clutch or by a safety clutch.

The magnitude of rotation which is being executed by the rotary actuator can be determined from the rotational speed and from the length of time the rotary actuator is actuated. A measuring apparatus for measuring the amount of rotation, for example, a rotary position transducer, is not necessary. If the method in accordance with the invention is to be used in adjusting apparatus with adjustment objects which differ in the size of the rotational ranges, the amount of rotation of the rotary actuator can be matched to the largest rotational range.

Of course, in the adjusting apparatus in accordance with the invention and in the method in accordance with the invention, the rotational range can be limited not only on one end by a rotary stop, rather the rotational range can additionally also be limited on the other end by a rotary stop.

The adjusting apparatus in accordance with the invention and the method in accordance with the invention can also be used in conjunction with systems, machines, devices, apparatus, etc. which can be problematical in terms of safety engineering, in which therefore an actual value which exceeds or falls below the setpoint of the adjustment object by a certain amount can lead to a safety problem. Consequently, another teaching of the invention with special importance is that the rotary actuator first turns the rotary final control element in the direction to the rotary stop at which the actual value of the adjustment object is not a problem in terms of safety engineering. This rotary stop is hereinafter also called the safety rotary stop.

If the adjusting apparatus in accordance with the invention and/or the method in accordance with the invention are implemented as is explained above, advantageously, the corresponding system, machine, device or apparatus is started up staggered in time. After a first start-up step, the system, the machine, the device or the apparatus is itself not yet “turned on”, is therefore still “passive”, and the rotary actuator turns the rotary final control element in the direction to the safety rotary stop. When the rotary actuator has turned the rotary final control element onto the safety rotary stop, the second start-up step follows. In this second start-up step, the system, the machine, the device or the apparatus is “turned on”, therefore “activated”, and the rotary actuator turns the rotary final control element until the adjustment object has reached the setpoint.

In particular, there are various possibilities for implementing the invention; this applies both with respect to the nuclear magnetic flowmeter in accordance with the invention and also to the adjusting apparatus in accordance with the invention and the method in accordance with the invention. In this respect reference is made to what is described below in conjunction with the drawings.

### BRIEF DESCRIPTION OF THE DRAWINGS

FIG. 1 shows very schematically the basic structure of a nuclear magnetic flowmeter and

FIG. 2 shows, also very schematically, the basic structure of the adjusting apparatus which is implemented in a nuclear magnetic flowmeter as shown in FIG. 1.

### DETAILED DESCRIPTION OF THE INVENTION

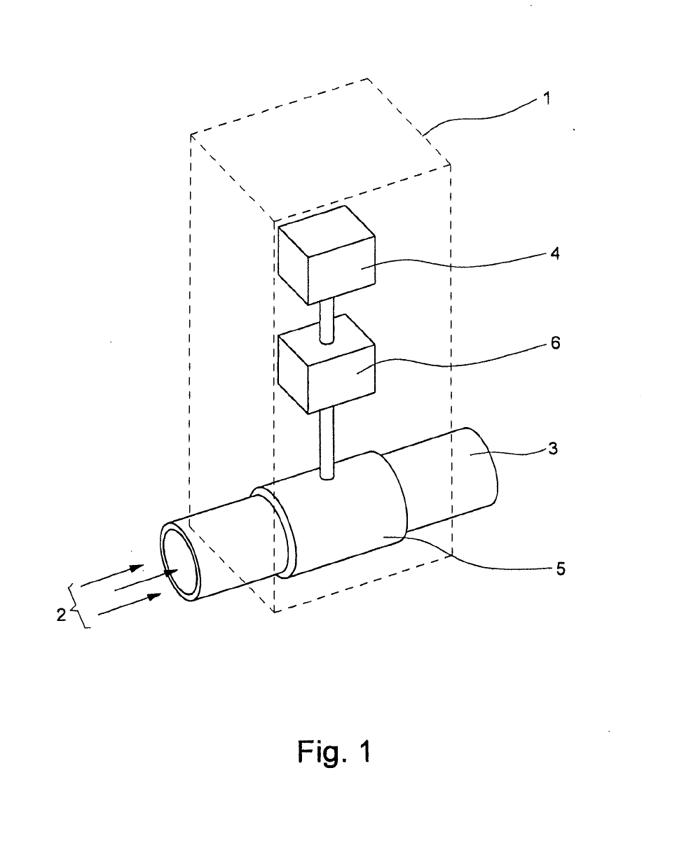

The nuclear magnetic flowmeter 1 only very schematically shown in FIG. 1, has a measuring tube 3 through which a medium 2 can flow, a magnetization apparatus (not shown), a signal apparatus 4 for generating signals which excite the medium 2 and/or for evaluating the signals of the excited medium 2, a signal coil 5 which is located on the measuring tube 3 for sending the signals which have been generated by the signal apparatus 4 and/or for receiving the signals of the excited medium 2 and a matching device 6 which is provided between the signal apparatus 4 and the signal coil 5, and which, like the nuclear magnetic flowmeter 1 in accordance with the invention overall, is only schematically shown in FIG. 1.

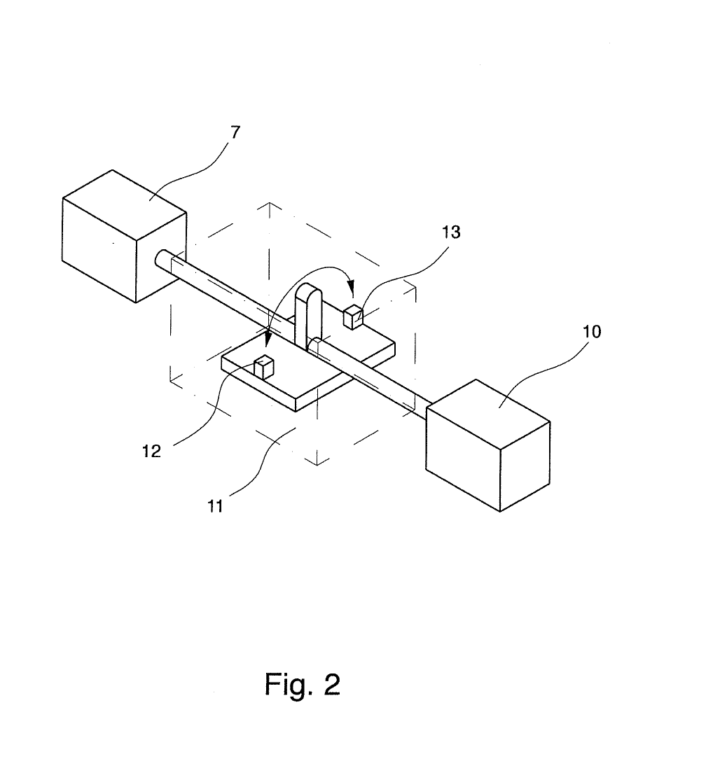

The matching device 6 has a reactive adjustment object 7 (FIG. 2) which can be adjusted mechanically in its value by a rotary motion and an adjusting apparatus 8 which is assigned to the adjustment object 7. The adjustment object 7 can be, in particular, a rotary capacitor.

The adjusting apparatus 8 which is shown only schematically in FIG. 2 in its basic structure and which is used in the flowmeter as shown in FIG. 1, has a rotary final control element 9 which influences the adjustment object 7, a rotary actuator 10 which acts on the rotary final control element 9, a torque clutch 11 which is provided between the rotary actuator 10 and the rotary final control element 9 and which transmits a torque which has been generated by the rotary actuator 10 to the rotary final control element 9, and at least one rotary stop 12, preferably also a second rotary stop 13. The rotary actuator 10 can, which is not shown, be made as an electric motor, preferably as a stepping motor. It is not shown that the torque clutch 11 can be made as a slip clutch, but preferably as a safety clutch. Finally the rotary stops 12, 13 are only suggested, therefore are not shown in particular.

If the adjusting apparatus in accordance with the invention 8 is implemented as described above, advantageously, the corresponding system, machine, device, or apparatus to which the adjusting apparatus 8 in accordance with the invention belongs, for example, therefore the nuclear magnetic flowmeter 1 in accordance with the invention, is started up staggered in time. Therefore, after a first start-up step, the system, the machine, the device, or the apparatus, for example, the nuclear magnetic flowmeter 1, is itself not yet “turned on”. Rather only after the first start-up step does the rotary actuator 10 turn the rotary final control element 11 in the direction to the first rotary stop 12, the safety rotary stop. When the rotary actuator 10 has turned the rotary final control element 9 onto the rotary stop 12, therefore the safety rotary stop, the second start-up step follows. In the course of it or afterwards, therefore the system, the machine, the device or the apparatus, for example, the nuclear magnetic flowmeter 1, is “turned on”, therefore “activated”, and the rotary actuator 10 turns the rotary final control element 9 until the adjustment object 7 has reached the setpoint.

What is claimed is:

1. A nuclear magnetic flowmeter, comprising:
a measuring tube through which a medium is flowable,
a signal apparatus for generating signals for at least one of exciting the medium and evaluating signals of an excited medium,
at least one signal coil located on the measuring tube for at least one of sending signals which have been generated by the signal apparatus and for receiving the signals of the excited medium, and
a matching device provided between the signal apparatus and the signal coil, the matching device having a reactive adjustment object which has a value that is mechanically adjustable by rotational motion and an adjusting apparatus associated with the adjustment object,
wherein that the adjustment apparatus has a rotary final control element which influences the adjustment object, a rotary actuator which acts on the rotary final control element, a torque clutch which is provided between the rotary actuator and the rotary final control element and which transmits torque generated by the rotary actuator to the rotary final control element, and at least one rotary stop.

2. The nuclear magnetic flowmeter as claimed in claim 1, wherein the torque clutch limits the torque which can be transmitted from the rotary actuator to the rotary final control element to a maximum torque.

3. The nuclear magnetic flowmeter as claimed in claim 2, wherein the torque clutch is a slip clutch.

4. The nuclear magnetic flowmeter as claimed in claim 2, wherein the torque clutch is a safety clutch.

5. The nuclear magnetic flowmeter as claimed in claim 2, wherein the torque clutch is adapted to be angularly synchronously re-engaged.

6. An adjusting apparatus for an adjustment object which has a value to which it is adjustable by a rotary motion, comprising a rotary final control element which influences the adjustment object, a rotary actuator which acts on the rotary final control element, a torque clutch which is provided between the rotary actuator and the rotary final control element and which transmits torque generated by the rotary actuator to the rotary final control element.

7. The adjusting apparatus as claimed in claim 6, wherein the torque clutch limits the torque which can be transmitted from the rotary actuator to the rotary final control element to a maximum torque.

8. The adjusting apparatus as claimed in claim 7, wherein the torque clutch is a slip clutch.

9. The adjusting apparatus as claimed in claim 7, wherein the torque clutch is a safety clutch.

10. The adjusting apparatus as claimed in claim 7, wherein the torque clutch is a safety clutch that is angularly synchronously re-engageable.

11. A method for operating an adjusting apparatus for an adjustment object which has a value to which it is adjustable by a rotary motion, comprising the steps of:
adjusting of the adjustment object by rotation of a rotary final control element with a rotary actuator, and
limiting torque which is transmittable between the rotary actuator and the rotary final control element to a maximum torque by producing slipping of the rotary actuator when a maximum torque between the rotary actuator and the rotary final control element is exceeded upon the rotary final control element has been rotated at least to the extent of the rotational range thereof.

12. The method as claimed in claim 11, wherein the rotation of the rotary actuator is limited on one end of the rotational range, by a rotary stop.

13. The method as claimed in claim 11, wherein the rotation of the rotary actuator is limited on each end of the rotational range by a respective rotary stop.

14. method as claimed in claim 12, wherein operation takes place staggered in time such that, after a first start-up step, a corresponding system, machine, device or apparatus with which the adjusting apparatus is associated is itself not yet “turned on”, is therefore still “passive”, the rotary actuator turns the rotary final control element in a direction to a one of the rotary stops which is active as a safety rotary stop, and wherein, when the rotary actuator has turned the rotary final control element onto the rotary stop which is active as the safety rotary stop, a second start-up step takes place in which the system, the machine, the device or the apparatus with which the adjusting apparatus is associated is “turned on”, and therefore “activated”, and the rotary actuator turns the rotary final control element until the adjustment object has reached a setpoint.
